(19) United States
(12) Patent Application Publication
(10) Pub. No.: US 2024/0001590 A1
(43) Pub. Date: Jan. 4, 2024

(54) TOOLING AND METHOD FOR INFILTRATING A SLURRY INTO A TEXTILE PREFORM

(71) Applicants: SAFRAN NACELLES, GONFREVILLE L'ORCHER (FR); SAFRAN CERAMICS, LE HAILLAN (FR)

(72) Inventors: Bertrand Léon Marie DESJOYEAUX, MOISSY-CRAMAYEL (FR); Nicolas EBERLING-FUX, MOISSY-CRAMAYEL (FR); Paul CARMINATI, MOISSY-CRAMAYEL (FR)

(21) Appl. No.: 18/343,277

(22) Filed: Jun. 28, 2023

(30) Foreign Application Priority Data
Jun. 29, 2022 (FR) 2206530

(51) Int. Cl. B28B 23/02; B28B 13/02; B28B 11/04

(52) U.S. Cl. CPC B28B 23/02; B28B 13/029; B28B 11/049; B28B 11/044; D06B 5/22

(57) ABSTRACT

A tooling for infiltrating a slurry into a textile preform includes a mold which includes an impregnation chamber including, on one of its face, an element for filtering a liquid phase of the slurry intended to receive a first face of a textile preform, the impregnation chamber being closed by a counter-mold located facing the filtration element; and an output vent present on the mold and configured to eliminate a filtrate of the filtration element at an elimination pressure, wherein the tooling also includes a circulation system for a slurry including an input port and an output port, the circulation system being configured to circulate the slurry in the impregnation chamber from the input port to the output port at a circulation pressure greater than the elimination pressure.

### CROSS-REFERENCE TO RELATED APPLICATIONS

This application claims priority to French Patent Application No. 22 06530, filed Jun. 29, 2022, the entire content of which is incorporated herein by reference in its entirety.

### FIELD

The present invention relates to the field of manufacture of parts of composite material, and more particularly to tooling and a method for infiltrating a slurry into a textile preform to form a matrix in the porosity of this preform.

### BACKGROUND

Densification, i.e. the formation of a matrix in a textile preform, can be accomplished by slurry injection. It consists of impregnating the textile preform with a liquid-based impregnation composition, or slurry, which penetrates into the porosity of the preform and grows a matrix in this preform.

Document FR 3 080 113 describes an example of infiltration of slurry into a textile preform, in which the preform is arranged in an impregnation chamber of a mold closed by a flexible membrane. A filter is present under the preform so as to filter a liquid phase (filtrate) from the slurry which is injected into the impregnation chamber. A pressure, greater than the injection pressure of the slurry, is applied to the flexible membrane so as to make the slurry penetrate into the preform. This infiltration example is called Injection Under Membrane or IUM.

It is also possible to accomplish this slurry impregnation by STM (“Slurry Transfer Molding” or molding by slurry injection), as described in document FR 3 030 505. In this case, it is the rigid walls of the mold which exert the compaction of the preform during and/or after the injection of slurry into the impregnation chamber to make the slurry penetrate into the preform.

Nevertheless, during impregnation by STM or IUM, the growth of the thickness of the deposing of the matrix in the preform is not monitored, but rather only the balance of the fillers losses (present in the slurry) between the slurry input opening and the filtrate. It is therefore possible to obtain a deposit front of solid fillers of the slurry obstructing the slurry input opening in the impregnation chamber while the preform is not fully colonized with solid fillers. It is possible to reduce this phenomenon by depositing a material draining above the preform, serving as a distribution element between the input opening and one of the face of the preform. But on the other hand, this increases the quantity of slurry to be injected into the impregnation chamber and the duration of the filtration of the liquid slurry phase.

It is therefore desirable to dispose of new tooling and a new method for infiltrating slurry into a textile preform allowing correcting the aforementioned disadvantages, in particular so that the solid particles of the slurry colonize the entire preform without increasing the quantity of slurry injected.

### SUMMARY

An aspect of the invention relates to tooling for infiltrating a slurry into a textile preform comprising:
a mold which comprises an impregnation chamber including, on one of its faces, a filtration element for filtering a liquid phase of the slurry intended to receive a first face of a textile preform, the impregnation chamber being closed by a counter-mold located facing the filtration element, and
an output vent present on the mold and configured to eliminate a filtrate from the filtration element at an elimination pressure,

wherein the tooling also comprises a circulation system for circulating a slurry comprising an input port and an output port, the circulation system being configured to circulate the slurry in the impregnation chamber from the input port to the output port at a circulation pressure greater than the elimination pressure.

Thanks to the circulation system, the slurry circulates under pressure in the impregnation chamber and does not stagnate. This avoids the particles or the powder contained in the slurry being deposited and agglomerating between the preform and the counter-mold, thus preventing the growth of the granular matrix between the textile preform and the counter-mold. Thus, the agglomeration of the particles or the powder of the slurry occurs only for the slurry impregnating the textile preform. Moreover, the elimination pressure allows removing the liquid phase of the slurry through the filtration element and the output vent.

According to a particular feature of the invention, the infiltration tooling comprises a recirculation circuit connecting the output port to the input port so that the slurry circulation system is a closed circuit.

The recirculation circuit can include a pump configured to bring the slurry to the circulation pressure.

This allows reintroducing the slurry removed through the output port into the impregnation chamber. Thus it is possible to reduce and optimize the quantity of slurry used for the growth of the matrix in the textile preform.

According to another particular feature of the invention, the circulation system comprises a drainage system extending between the input port and the output port.

The drainage system is beneficially located at a second face of the textile preform, opposite to the first face. The textile preform is thus positioned between the filtration element and the drainage system.

According to a first embodiment, the drainage system comprises a part made of porous material intended to be placed on a second face of the textile preform opposite to the first face. The part made of porous material is for example a grid.

According to a second embodiment, the drainage system comprises channels placed or formed on an internal surface of the counter-mold and intended to be facing the second face of the textile preform.

The first and second embodiments can be combined, i.e. the drainage system can comprise both a part made of porous material and channels placed or formed on an internal surface of the counter-mold.

According to another particular feature of the invention, the input and output ports are intended to be located facing a lateral face of the textile preform. When the circulation system comprises a drainage system, the input and output ports is beneficially located facing a lateral face of the drainage system.

The input and output ports are thus located on the periphery of the preform, while the filtration element and the output vent are located below the preform. The elimination pressure at the output vent thus does not perturb the circulation of slurry, and the slurry can actually circulate in the entire impregnation chamber to impregnate the entire preform.

According to another particular feature of the invention, the input port is present on the counter-mold or on the mold and the output port is present on the counter-mold or on the mold.

According to another particular feature of the invention, the tooling also comprises a flexible membrane intended to be located between the counter-mold and the textile preform.

This allows accomplishing the formation of the matrix in the textile preform using IUM.

Another aspect of the invention is a method for infiltrating a slurry into a textile preform implemented in infiltration tooling according to an aspect of the invention, the method comprising:
placing a textile preform in the impregnation chamber by resting one of the faces of the preform on the filtration element and closing the infiltration tooling by placing the counter-mold on the textile preform, and
infiltrating the textile preform with a slurry by circulating the slurry in the impregnation chamber from the input port to the output port under a circulation pressure while filtering and eliminating a liquid phase of the slurry through the filtration element and the output vent under an elimination pressure less than the circulation pressure.

According to a particular feature of the invention, the pressure difference between the circulation and elimination pressures is comprised between 1·10⁵ Pa (1 bar) and 20·10⁵ Pa (20 bar).

This allows guaranteeing that the slurry actually circulates in the impregnation chamber without the particles or the powder agglomerating between the counter-mold and the textile preform.

According to another particular feature of the invention, the slurry leaving the output port is reintroduced into the impregnation chamber through the input port.

According to another particular feature of the invention, the circulation speed of the slurry in the circulation system is at least two times greater than the filtration speed of the liquid phase of the slurry through the filtration element and the output vent.

### BRIEF DESCRIPTION OF THE DRAWINGS

Other features and benefits of the present invention will be revealed by the description given below, with reference to the appended drawings which illustrate exemplary embodiments of it bereft of any limiting nature.

FIG. 1 shows, schematically and partially, infiltration tooling according to an embodiment of the invention.

FIG. 2 shows, schematically and partially, infiltration tooling according to another embodiment of the invention.

FIG. 3 shows schematically a method for infiltrating a slurry into a textile preform according to an embodiment of the invention.

FIG. 4A shows, schematically and partially, infiltration tooling according to an embodiment in the case of a textile preform with variable thickness.

FIG. 4B shows, schematically and partially, the infiltration tooling of FIG. 4A and the infiltration of slurry into the preform over time.

FIG. 4C shows, schematically and partially, the infiltration tooling of FIG. 4A and the infiltration of slurry into the preform over time.

FIG. 4D shows, schematically and partially, the infiltration tooling of FIG. 4A and the infiltration of slurry into the preform over time.

FIG. 4E shows schematically and partially, the infiltration tooling of FIG. 4A and the infiltration of slurry into the preform over time.

### DETAILED DESCRIPTION

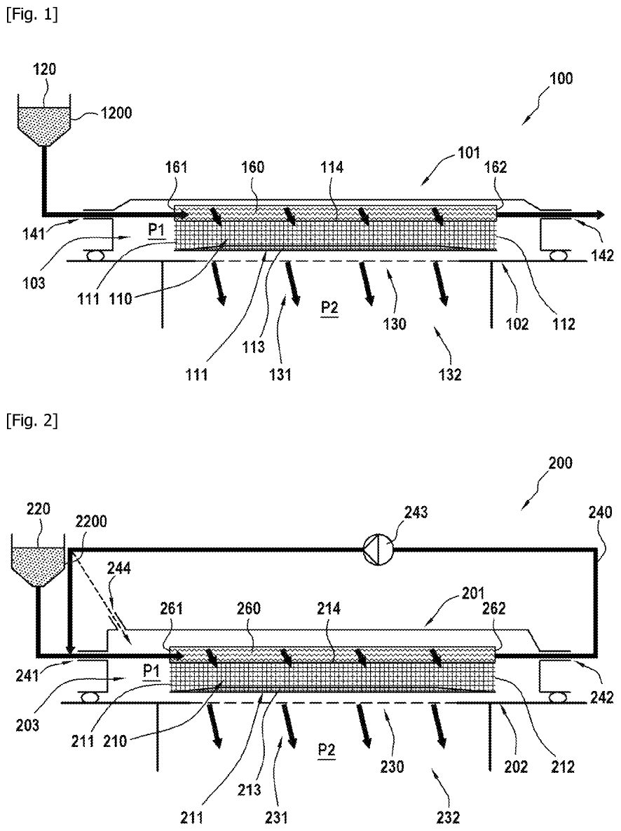

FIG. 1 shows, schematically and partially, infiltration tooling 100 according to an embodiment of the invention.

The tooling 100 comprises a mold 102 and a counter-mold 101 which delimit the impregnation chamber 103 in which a textile preform 110 is placed, which is impregnated with a slurry 120. The counter-mold 101 can be formed by a rigid part or by a flexible membrane. The impregnation chamber 103 includes in its lower portion a filtration element 130 which filters a liquid phase 131 of the slurry 120. The slurry 120 is intended to allow the formation of a matrix of the part to be manufactured. The slurry 120 thus comprises solid particles suspended in a liquid phase.

At least one output vent 132 is present on the mold 102 and allows eliminating the filtrate 131 from the filtration element 130. The filtration element 130 and the output vent 132 allow filtering the liquid phase 131 of the slurry 120 after its impregnation into the textile preform 110. The output vent 132 is at an elimination pressure P2.

More precisely, the filtration element 130 and the output vent 132 are located facing a first main face 113 of the textile preform 110.

The tooling 100 also comprises a system for circulating the slurry 120 comprising a slurry reservoir 1200, an input port 141, an output port 142 and a part made of porous material 160, for example a grid. The part made of porous material 160 is placed on a second main face 114 of the preform 110, opposite to the first main face 113 of the preform 110, facing the filtration element 130. The preform 110 is thus located between the filtration element 130 and the part made of porous material 160. The circulation system allows circulating the slurry 120 in the impregnation chamber 103 from the input port 141, supplied by the reservoir 1200, to the output port 142 at a circulation pressure P1. The pressure P1 is greater than P2. It is considered that the pressure difference between the input port 141 and the output port 142 is virtually zero; in fact, it will have a maximum on the order of 0.5 bar (0.5·10⁵ Pa).

The input 141 and output 142 ports are placed on the counter-mold 101 facing a lateral face 161, 162 of the part made of porous material 160, in particular the input port 141 facing the lateral face 161 and the output port 142 facing the lateral face 162. The two ports 141, 142 face one another in order to allow the slurry 120 to circulate in the impregnation chamber 103. Thus, when the slurry 120 penetrates into the impregnation chamber 103, a portion of the slurry impregnates the textile preform 110 and the other portion leaves the chamber 103 through the output port 142. By impregnating the preform 110, it deposits fillers (or particles or powder) in the preform 110, which allows making a matrix 110 grow in the porosity of the preform 110; while the liquid phase of the slurry 131 is eliminated via the output vent 132.

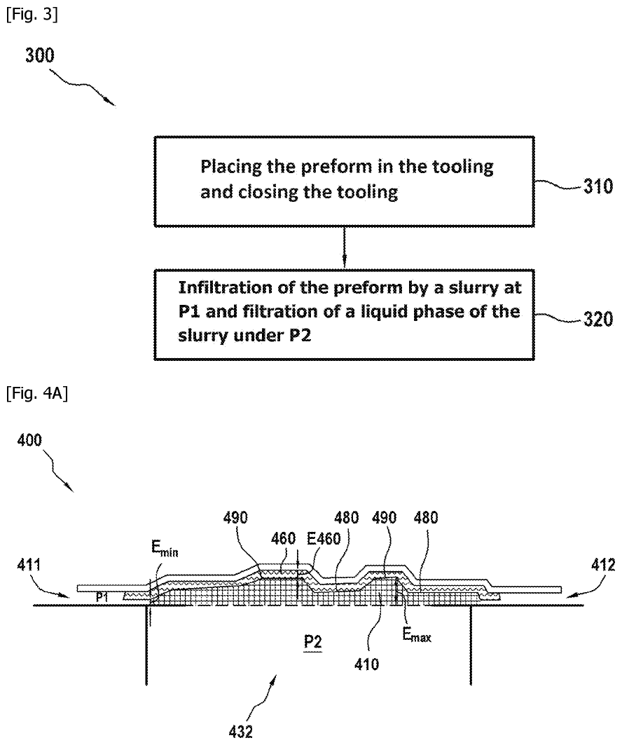

FIG. 2 shows, schematically and partially, infiltration tooling 200 according to another embodiment of the invention.

The tooling 200 comprises a mold 202 and a counter-mold 201 which delimit an impregnation chamber 203 in which is placed a textile preform 210 which is impregnated with a slurry 220. The impregnation chamber 203 includes, in its lower portion, a filtration element 230 which filters a liquid phase 231 of the slurry 220. As before, the slurry 220 is intended to allow the formation of a matrix and thus comprises solid particles suspended in a liquid phase.

At least one output vent 232 is present on the mold 202 and allows eliminating the filtrate 231 from the filtration element 230. The filtration element 230 and the output vent 232 allow filtering the liquid phase 231 of slurry 220 after its impregnation into the textile preform 210 at the elimination pressure P2.

The tooling 200 also comprises a circulation system for the slurry 220 comprising a slurry 220 reservoir 2200, an input port 241, an output port 242, a part made of porous material 260 and a recirculation circuit 240 equipped with a recirculation pump 243. The circulation system allows circulating the slurry 220 in the impregnation chamber 203 from the input port 241 to the output port 242 at a circulation pressure P1. The pressure P1 is greater than P2. The recirculation circuit 240 extends between the output port 242 and the input port 241 so as to be able to return the slurry removed through the output port 242 to the input port 241. The slurry 220 circulation system thus forms a closed loop circuit. Just as for FIG. 1, it is considered that the pressure difference between the input port 241 and the output port 242 is virtually zero, because it has a maximum on the order of 0.5 bar (0.5·10⁵ Pa).

In this embodiment, the same input port 241 is used to inject slurry 220 into the impregnation chamber 203, whether it originates in the reservoir 2200 or in the outlet port 242.

In another embodiment, shown in broken lines in FIG. 2, the circulation system comprises an additional input port 244 which allows injecting slurry 220 leaving the output port 242 into the impregnation chamber 203. The input port 241 continues to be used to inject slurry 220 originating in the reservoir 2200.

As before, the input 241 and output 242 ports are placed on the counter-mold 201 facing a lateral face 261, 262 of the part made of porous material 2460, in particular the input port 241 faces the lateral face 261 and the output port 242 faces the lateral face 262. The additional input port 244 is placed in proximity to the input port 241. The input ports 241, 244 are placed facing the output port 242 in order to allow the slurry 220 to circulate in the impregnation chamber 203, while the output vent 232 is located facing a main face 213 of the preform 210 to be able to remove the liquid phase 231 of the slurry 220 after its infiltration into the preform 210.

In order to ensure the circulation of the slurry in the impregnation chamber, whether in an open circuit (FIG. 1) or in a closed loop circuit (FIG. 2), the input and output ports of the slurry are placed laterally at the output vent, i.e. they are placed facing a lateral face of the preform and, in the examples of FIGS. 1 and 2, facing a lateral face of the porous material, while the output vent faces a main face of the preform. Moreover, the slurry input ports and output port are not located facing the same lateral face of the preform or the same lateral face of the porous material.

Regardless of the embodiment, the infiltration tooling 100 or 200 can comprise a flexible membrane located between the counter-mold 101, 201 and the textile preform 110, 210. This flexible membrane allows, for example, accomplishing the infiltration of the slurry into the preform by IUM.

Regardless of the embodiment, the circulation system can comprise a plurality of input ports and a plurality of output ports. The input and output ports are advantageously distributed on the periphery of the preform in order to favor the circulation of the slurry in the entire preform.

Regardless of the embodiment, each input port 141, 241, 244 can be present on the mold 102, 202 or on the counter-mold 101, 201 and each output port 142, 242 can be present on the mold 102, 202 or on the counter-mold 101, 201.

An aspect of the invention has been described with a slurry circulation system comprising a part made of porous material. However, the slurry circulation system can comprise, in place of or in addition to said part made of porous material, channels placed on an internal surface of the counter-mold which will be facing the second main face 114, 214 of the preform. The channels extend between the input and output ports.

In a similar manner to the part made of porous material, the channels allow improving the circulation of the slurry in the impregnation chamber and limiting the agglomeration of particles from the slurry between the counter-mold and the preform.

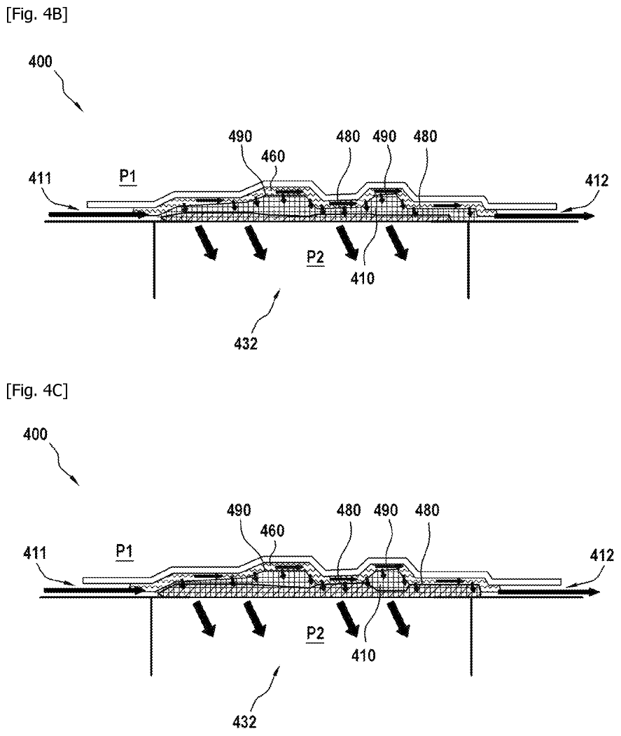

FIG. 3 shows schematically a method 300 for infiltrating a slurry into a textile preform according to one embodiment of the invention. The method 300 is for example implemented on infiltration tooling 100 or 200 as described with reference to FIGS. 1 and 2.

The method 300 comprises, in a step 310, placing the textile preform 110, 210 in the impregnation chamber 103, 203 by resting one of the faces of the preform on the filtration element 130, 230, placing the part made of porous material on the textile preform and closing the infiltration tooling 100, 200 by placing the counter-mold 101, 201 on the part made of porous material.

Then, in a step 320, the slurry 120, 220 is injected into the impregnation chamber 103, 203 so that it infiltrates the textile preform 110, 210 and circulates in the impregnation chamber 103, 203 from the input ports 141, 241, 244 to the output port 142, 242. The circulation of the slurry 120, 220 occurs at a circulation pressure P1. During the infiltration of the preform 110, 210, the liquid phase 131, 231 of the slurry 120, 220 is filtered by the filtration element 130, 230 and removed through the output vent 132, 232 at an elimination pressure P2 less than the circulation pressure P1.

Regardless of the embodiment, the pressure difference between P1 and P2 can be comprised between 1·10⁵ Pa (1 bar) and 20·10⁵ Pa (20 bar); it is for example 5·10⁵ Pa (5 bar).

Regardless of the embodiment, the circulation pressure P1 can be comprised between 5·. 10⁵ Pa (5 bar) and 20·10⁵ Pa (20 bar).

Regardless of the embodiment, the elimination pressure P2 is less than or equal to 1·10⁵ Pa (1 bar).

Regardless of the embodiment, the circulation speed of the slurry in the circulation system is at least two times greater than the filtration speed of the liquid phase of the slurry by the filtration element and the output vent.

Regardless of the embodiment, the slurry comprises solid fillers with a proportion comprised between 2% and 30% of the volume.

Regardless of the embodiment, for a ceramic part, the slurry comprises ceramic fillers with a proportion comprised between 10% and 30% by volume, and for example an organic binder with a proportion comprised between 0% and 20% by mass and a plasticizer with a proportion comprised between 0% and 20% by mass.

The ceramic fillers comprise for example carbide particles (for example silicon carbide), alumina, mullite or borides with a d50 size comprised between 0.1 μm and 2 μm. The binder and/or the plasticizer are for example polyvinyl alcohol (PVA), polyethylene glycol (PEG), glycerol, polyvinylpyrrolidone (PVP) or other organic binders such as soaps or oils. The plasticizer is for example polyethylene glycol 200 (PEG 200).

Regardless of the embodiment, the textile preform can be produced entirely or partially by stacking strata or folds obtained by two-dimensional (2D) weaving. The preform can also be produced entirely or partially by three-dimensional (3D) weaving. What is meant here by two-dimensional weaving is a conventional weaving mode in which each weft yarn passes from one side to the other of the yarns of a single layer of warp, or conversely. What is meant here by three-dimensional weaving is a weave for which the warp yarns pass through several layers of weft yarns, or weft yarns pass through several layers of warp yarns.

The textile preform can also be produced entirely or partially by laps of unidirectional fibers, which can be obtained by automatic placement of fibers or by filament winding.

The textile preform can also be produced from fibers consisting of the following materials: alumina, mullite, silica, an aliminosilicate, a borosilicate, silicon carbide, carbon, or a mixture of several of these materials.

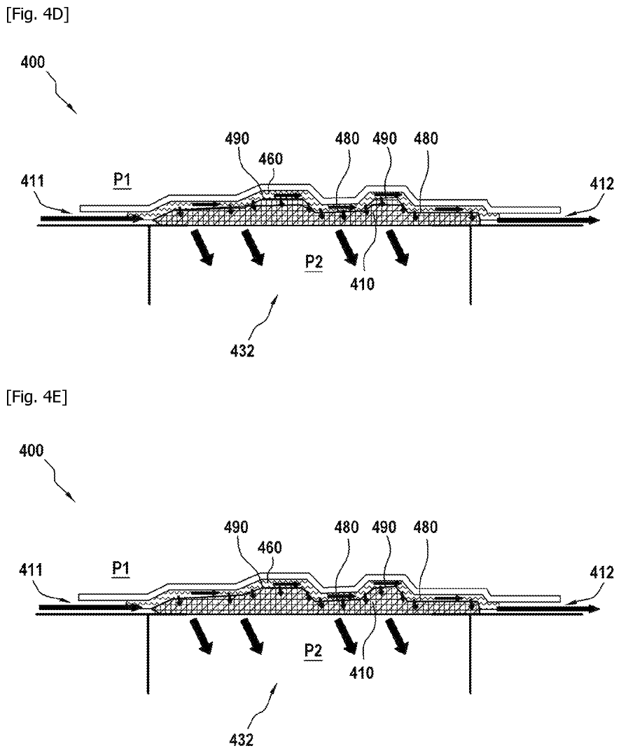

In the example of FIGS. 1 and 2, a textile preform with a constant thickness has been placed in the impregnation chamber of the infiltration tooling of the invention. It is possible, however, to place a textile preform with a variable thickness as shown in FIGS. 4A, 4B, 4C, 4D and 4E, these figures showing the impregnation of the slurry over time in the textile preform according to the method of the invention implemented in infiltration tooling of the invention.

The preform 410 has a thickness that is variable between a maximum thickness Emax and a minimum thickness Emin. It is arranged in infiltration tooling 400 according to the invention, which comprises a circulation grid 460, which corresponds to the part made of porous material 160, 260 of FIGS. 1 and 2. The thickness E460 of the circulation grid 460 is small compared to the variation of thickness of the preform 410. For example, the textile preform 410 has a thickness that varies between 0.5 mm and 8 mm, while the circulation grid 460 has a thickness E460 comprised between 0.5 mm and 3 mm.

As explained previously, the slurry penetrates into the impregnation chamber of the tooling 400 from the input port 411 and circulates until the output port 412 under a circulation pressure P1. The slurry infiltrates the textile preform 410 and its liquid phase is filtered and eliminated by the output vent 432. The circulation of slurry from the input port 411 to the output port 412, its infiltration into the preform 410 and the elimination of its liquid phase are shown symbolically in FIGS. 4B, 4C, 4D and 4E by the different arrows. The elimination pressure of the liquid phase of the slurry at the output vent 432 is less than the circulation pressure of the slurry between the input 411 and output 412 ports. As explained previously, this allows guaranteeing good circulation of the slurry in the entire preform 410 and the impregnation chamber. Thus, the particles or powder of the slurry do not stagnate at the hollows 480 or the protrusions 490 of the textile preform 410 and are distributed over the entire preform 410.

The expression “comprised between . . . and . . . ” should be understood to include the limits.

It will be appreciated that the various embodiments, features and aspects of the inventions described previously are combinable according to any technically permissible combinations.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

1. A tooling for infiltrating a slurry into a textile preform comprising:
a mold which comprises an impregnation chamber including on one of its faces a filtration element for filtering a liquid phase of the slurry intended to receive a first face of a textile preform, the impregnation chamber being closed by a counter-mold located facing the filtration element, and
an output vent present on the mold and configured to eliminate a filtrate of the filtration element at an elimination pressure,
wherein the tooling also comprises a circulation system adapted to circulate a slurry comprising an input port and an output port, the circulation system being configured to circulate the slurry in the impregnation chamber from the input port to the output port at a circulation pressure greater than the elimination pressure.

2. The infiltration tooling according to claim 1, comprising a recirculation circuit connecting the output port to the input port so that the slurry circulation system is a closed circuit.

3. The infiltration tooling according to claim 1, wherein the circulation system comprises a drainage system extending between the input port and the output port.

4. The infiltration tooling according to claim 3, wherein the drainage system comprises a part made of porous material intended to be placed on a second face of the textile preform opposite to the first face.

5. The infiltration tooling according to claim 3, wherein the drainage system comprises channels placed or formed on an internal surface of the counter-mold and intended to be facing the second face of the textile preform.

6. The infiltration tooling according to claim 1, wherein the input and output ports are intended to be located facing a lateral face of the textile preform.

7. The infiltration tooling according to claim 1, wherein the input port is present on the counter-mold or on the mold and the output port is present on the counter-mold or on the mold.

8. The infiltration tooling according to claim 1, also comprising a flexible membrane intended to be located between the counter-mold and the textile preform.

9. A method for infiltrating a slurry into a textile preform implemented in infiltration tooling according to claim 1, the method comprising:
placing a textile preform into the impregnation chamber by resting one of the faces of the preform on the filtration element, and closing the infiltration tooling by placing the counter-mold on the textile preform, and
infiltrating the textile preform with a slurry by circulating the slurry in the impregnation chamber from the input port toward the output port under a circulation pressure while filtering and eliminating a liquid phase of the slurry through the filtration element and the output vent under an elimination pressure less than the circulation pressure.

10. The infiltration method according to claim 9, wherein the pressure difference between the circulation and elimination pressures is comprised between 1·10⁵ Pa and 20·10⁵ Pa.

11. The infiltration method according to claim 9, wherein the slurry leaving the output port is re-introduced into the impregnation chamber through the input port.

12. The infiltration method according to claim 9, wherein the circulation speed of the slurry in the circulation system is at least two times greater than the filtration speed of the liquid phase of the slurry by the filtration element and the output vent.
